(19) United States
(12) Patent Application Publication
(10) Pub. No.: US 2014/0311268 A1
(43) Pub. Date: Oct. 23, 2014

(54) OILING DEVICE FOR AN AXLE WITH SPUR GEAR

(71) Applicants: Thomas Grosswald, Tiefenbach (DE); Enrico Herfurth, Passau (DE); Erich Katzensteiner, Pentling (DE)

(72) Inventors: Thomas Grosswald, Tiefenbach (DE); Enrico Herfurth, Passau (DE); Erich Katzensteiner, Pentling (DE)

(21) Appl. No.: 13/867,195

(22) Filed: Apr. 22, 2013

(51) Int. Cl. F16H 57/04

(52) U.S. Cl. CPC F16H 57/0493; F16H 57/0457
USPC 74/468

(57) ABSTRACT

An oiling device for an axle with spur gearing comprising a first rotating component which is surrounded by a housing and immersed in a lubricant. A first shaft is mounted to rotate by way of first and second bearings and is continuously connected to a third rotating component and a second rotating component that engages the first rotating component and is arranged above the surface of the lubricant. A fourth rotating component is continuously connected to a second shaft that is spaced from the first shaft. The lubricant is at least partially dispersed in the housing by rotation of the first rotating component. The second shaft and the first rotating component are arranged within the same housing and the lubricant that is dispersed by the first rotating component can be caught and selectively dispersed by at least one collecting channel.

This application claims priority from German patent application serial no. 10 2012 207 134.2 filed Apr. 27, 2012.

### FIELD OF THE INVENTION

The present invention concerns an oiling device for an axle with spur gearing, as used for example in vehicles with more than one driven axle.

### BACKGROUND OF THE INVENTION

It is known to design rotating components so that they can be partially immersed in oil or lubricants and thereby produce a conveying action for supplying lubricant to remote components.

In this context, U.S. Pat. No. 2,033,246 discloses a tandem axle as used for example in vehicles having more than one driven axle. In that arrangement the axle-drive bevel gear and the adjacent spur gear are each surrounded by a separate housing. A horizontal duct connects the sump of the spur gear to the housing of the bevel gear. In that way lubricant passes from the bevel gear housing into the sump of the spur gear, so enabling an even filling level of the lubricant in both housings. The gearwheels of the spur gearing convey this lubricant upward, where it is captured by ducts or pockets and distributed farther into the housing. Furthermore, the lubricant passes in this way into another housing which surrounds a drive-through shaft.

### SUMMARY OF THE INVENTION

The purpose of the present invention is to provide an oiling device for an axle with spur gearing, which ensures an adequate supply of lubricant to bearings and gearwheels during driving operation. In this case additional components, as required for the creation of a lubricant circuit by means of a separate pump and corresponding inlet and outlet lines, should not be needed. Rather, the intention is to design the existing components in a simple and inexpensively produced manner, and to use them suitably for providing an adequate lubricant supply.

This objective is achieved by an oiling device having a first rotating component that is surrounded by a housing and can be partially immersed in a lubricant. In addition the oiling device comprises a first bearing and a second bearing, whereby a first shaft is mounted and able to rotate, which is connected in a rotationally fixed manner to a second rotating component that engages with the first rotating component and to a third rotating component and is arranged above the surface of the lubricant, and a fourth rotating component which is connected in a rotationally fixed manner to a second shaft arranged a distance away from the first shaft.

At least some of the lubricant is picked up by the first rotating component, thrown off again by its rotational movement and thereby again dispersed in the housing. In a preferred embodiment the second shaft and the first rotating component are arranged in the same housing.

It is further preferred that the lubricant thrown off by the rotational movement of the first rotating component can be captured by at least one collecting channel and distributed selectively. Particularly preferably, the collecting channel has a contour curved or angled upward, whereby the lubricant collected can be retained and passed on selectively. The first rotating component and the second rotating component can for example form a bevel gearset, wherein the first rotating component can be in the form of a bevel gear and the second rotating component can be in the form of a pinion. The third and fourth rotating components can for example be in the form of gearwheels, so-termed spur gears.

In a further preferred embodiment a partition wall divides the housing between the second rotating component and the third rotating component and fourth rotating component into a first space, for example a so-termed bevel gearset space, and a second space, for example a so-termed spur gear space. Further, it is preferable for at least the first rotating component to be in the first space and at least the third rotating component and the fourth rotating component to be in the second space. Particularly preferably, the partition wall is arranged perpendicularly to the longitudinal axis of the vehicle. However, any positioning angles different from that are also conceivable. The partition wall can for example be cast in place along with the housing itself, or it can be positioned in the housing in the form of a separate component and fixed therein by clamping, screwing or some other connection means. Particularly preferably, the partition wall has two apertures that enable the first and second shafts to pass through or the first and second bearings to be held. The inside wall of the housing and the partition wall particularly preferably have as smooth a surface as possible in order to avoid undesired turbulence or disadvantageous lubricant dispersion. This means that the surface is made flat and projections, recesses or edges are eliminated so far as possible.

In the present context a longitudinal axis is understood to be an axis which, in the fitted condition, extends parallel to the road surface and is directed along the vehicle's driving direction.

In a further preferred embodiment the lubricant thrown off by the first rotating component is passed by way of the collecting channel in the first space to a third bearing. The rotational movement of the second shaft causes the lubricant to be distributed in the third bearing. In this way, among other things a lubricant film is built up in the bearing, whereby the effects of wear are reduced and at the same time the heat produced by the rotational movement of the second shaft is dissipated by the lubricant.

Particularly preferably, during driving operation the rotation of the first rotating component constantly delivers more lubricant to the collecting channel. Excess lubricant flows through the first bearing and thus preferably passes from the first into the second space. There, under the action of gravity it preferably flows down along the partition wall and collects at the bottom of the second space.

In a particularly preferred embodiment the third bearing is a conical roller bearing, such that the side with the smaller conical roller bearing diameter faces toward the first rotating component. In a particularly preferred manner the lubricant conveying action resulting from the geometry of the conical roller bearing favors the above-described flow direction of the lubricant.

In another preferred embodiment the third rotating component is located in the second space and can be partially immersed in the lubricant present therein. It is also preferable for a second collecting channel to be arranged inside the housing so that lubricant thrown up by the third rotating component can be caught and passed by way of a channel to behind a fourth bearing. The second shaft is mounted and able to rotate by virtue of this fourth bearing. Particularly preferably, the fourth bearing is on the side of the partition wall facing away from the first rotating component. The lubricant passing behind the fourth bearing via the channel is delivered thereto, in order, on the one hand, to build up a sufficient lubricant film and, on the other hand, to dissipate the heat produced. Preferably, the lubricant flows back through the bearing into the lower part of the second space.

In a particularly preferred embodiment the fourth bearing is also a conical roller bearing which, together with the third bearing, is fitted in an X bearing arrangement. This means that the larger radius of the fourth, or conical roller bearing faces toward the first rotating component while its smaller radius faces away from the first rotating component.

By virtue of the conveying action of the conical roller bearing, the design of the fourth bearing in the form of a conical roller bearing favors the already described flow direction of the lubricant.

Particularly preferably, the second collecting channel is positioned in the housing horizontally, i.e. parallel to the longitudinal axis. In a further preferred embodiment the second collecting channel is positioned, for example, in the direction of the fourth bearing.

In a further example embodiment, a third collecting channel is arranged in the second space on the side of the housing opposite from the second collecting channel. In this case ‘opposite’ can mean that the third collecting channel is positioned in the second space mirror-symmetrically relative to a line of symmetry passing though the mid-points of the first and second shafts. Basically, however, an arrangement of the third collecting channel in some different position on the side of the second space opposite the second collecting channel is also conceivable.

The third collecting channel also leads the captured lubricant behind the fourth bearing, so that its lubricant supply is improved still more. In principle it is also conceivable to provide further collecting channels in the second space, although if the second and third collecting channels are of sufficient size this is not strictly necessary.

It is also preferable for the partition wall to have at least one opening. The opening is ideally positioned such that it is approximately at the level where the third rotating component engages with the fourth rotating component. The opening serves to pass excess lubricant from the second space into the first space in order to avoid any lubrication deficit there. For that purpose it is positioned close to the housing wall of the second space. Particularly preferably, the opening is positioned above the surface of the lubricant present in the second space. This, for example, prevents too large an amount of lubricant from flowing directly from the second space to the first space. For example, that would have the result that the lubricant level in the second space fell too far, and then the third rotating component could no longer immerse itself sufficiently deeply into the lubricant. That could perhaps result in deficient lubricant of the bearings and rotating components present in the second space.

In a further preferred embodiment the partition wall has a second opening that is higher than the first opening. It is also preferable for the first and second openings to be separated by a collecting rib which projects into the second space in the form of an elevation along the partition wall. The collecting rib can for example be cast, but can also consist of a strip of sheet metal welded on or attached in some other way. The lubricant thrown up by the third rotating component is partially caught by the collecting rib, passed into the opening, and so transferred from the second space into the first space. Analogously for example, some of the lubricant that flows down the partition wall under the force of gravity is also caught and passed into the second opening so that it too is transferred from the second space into the first space.

In this way a circulation of lubricant between the second and first spaces is created. On the one hand this prevents deficient lubrication in either of the two spaces, and on the other hand it avoids excessive temperature differences between the first and second spaces thanks to the continued circulation of the lubricant.

In a further preferred embodiment the partition wall has a third opening and a fourth opening that is positioned above it, such that the third and fourth openings are preferably also separated by a second collecting rib between them. Also preferably, the third and fourth openings and the second collecting rib are on the opposite side of the partition wall from the first and second openings and the first collecting rib in the second space. The third and fourth openings and the second collecting rib can for example be arranged mirror-symmetrically relative to the first and second openings and the first collecting rib, along a line of symmetry that passes through the mid-points of the first and second shafts. Basically, however, any other positioning above or below the first and second openings and the first collecting rib is also conceivable. The use of the third and fourth openings and the second collecting rib allows a larger quantity of the lubricant present in the second space to be returned to the first space.

According to need or the application concerned, the quantity of lubricant flowing back from the second into the first space can be adapted by closing off one or more openings by means of a plug, a screw or some other closure element. Likewise, such a closure element can prevent any, or too much of the lubricant thrown up by the first rotating component from passing directly, for example through the opening in the partition wall, from the first space into the second space. Furthermore this procedure, among other things, reduces the number of different variants since the same partition wall arrangement can be used for different applications.

A particularly preferred embodiment of the oiling device has a fourth collecting channel on the side of the housing opposite from the first collecting channel. By virtue of this fourth collecting channel some of the lubricant can be caught and passed to a fifth bearing through which the second shaft is mounted and able to rotate, on the side of the second shaft opposite the fourth rotating component. For example, the fourth collecting channel extends into the first space in the form of a continuation of the housing wall in the area of the lower edge of the fifth bearing. Preferably, it has a contour curved or angled upward.

### BRIEF DESCRIPTION OF THE DRAWINGS

Preferred embodiments of the invention are explained in more detail with reference to the attached drawings, which show:

FIG. 1: A sectional drawing of an axle with spur gearing;

FIG. 2: A perspective view of a possible embodiment of the second collecting channel in the second space;

FIG. 3: A perspective view of another possible embodiment of the second collecting channel in the second space;

FIG. 4: A sectional drawing of a possible embodiment of the second collecting channel, the opening, the second opening and the collecting rib;

FIG. 5: A sectional drawing of a further possible embodiment of the second and third collecting channels and of the collecting rib and the second collecting rib;

FIG. 6: A section of a perspective view of a possible example embodiment of the opening, the second opening and the collecting rib.

### DETAILED DESCRIPTION OF THE PREFERRED EMBODIMENTS

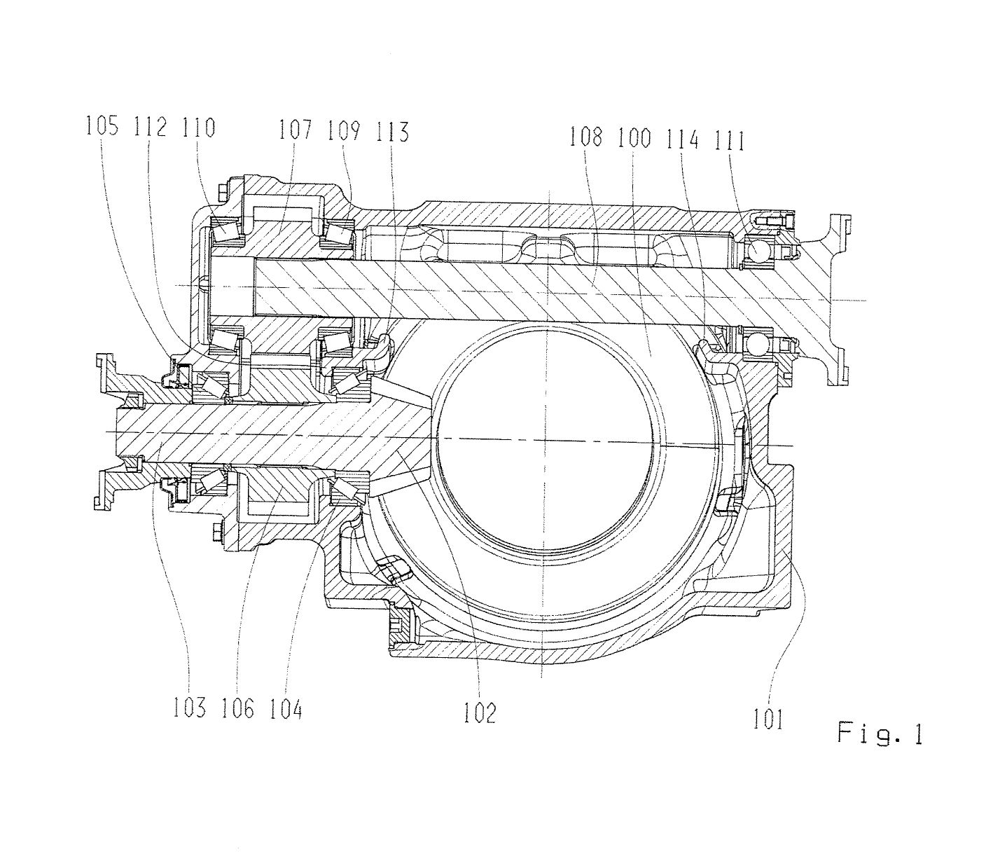

FIG. 1 shows a first rotating component 100, as found for example in the form of an axle drive bevel gear in a differential or an axle with spur gearing. The first rotating component 100 is surrounded by a housing 101 and is at least partially immersed in a lubricant. During rotational movement of the first rotating component 100, the lubricant is carried up by it, shortly afterward thrown off by centrifugal force, and thereby dispersed in the housing. The first rotating component 100 is permanently engaged with a second rotating component 102. In the present case the second rotating component 102 is a bevel gear and is connected in a rotationally fixed manner to a first shaft 103.

The first shaft 103 is mounted to rotate in a first bearing 104 and a second bearing 105. In this case the first bearing 104 is on the side of the first shaft 103 facing toward the first rotating component 100, whereas the second bearing 105 is arranged on the side of the first shaft 103 opposite the first bearing 104. The first bearing 104 and the second bearing 105 are thus in an O-arrangement relative to one another.

Furthermore, a third rotating component 106 is also connected in a rotationally fixed manner to the first shaft 103. The rotating component 106 engages with a fourth rotating component 107. In turn, the fourth rotating component 107 is connected in a rotationally fixed manner to a second shaft 108, this second shaft 108 being positioned a distance away from the first shaft 103 and being mounted to rotate in a third bearing 109, a fourth bearing 110 and a fifth bearing 111. In the assembled position the second shaft 108 is above the first shaft 103 and at the same time in the upper area of the first rotating component 100 in the housing 101. The fifth bearing 111 is positioned on the side of the second shaft 108 opposite from the fourth rotating component 107.

On the side of the fourth rotating component 107 facing toward the fifth bearing 111 is arranged the third bearing 109, and on the side of the fourth rotating component 107 opposite the third bearing 109 is arranged the fourth bearing 110. Thus, the third bearing 109 and the fourth bearing 110 are in an X-arrangement.

In an area between the first rotating component 100 and the third rotating component 106 or fourth rotating component 107, the housing 101 is divided by a partition wall 112 into a first space and a second space. In this case for example the first rotating component 100 is in the first space and the fourth rotating component 107 is in the second space. The partition wall 112 is designed so that the first shaft 103 and the second shaft 108 can pass through the partition wall 112, and provides the possibility of holding the first bearing 104 and the third bearing 109.

In the lower area of the third bearing a collecting channel 113 projects from the partition wall 112, into the first space. The collecting channel 113 has a contour which is at first horizontal or approximately so and is then curved or angled upward in the direction of the first rotating component 100. On the side of the housing 101 opposite to the collecting channel 113, in the lower area of the fifth bearing 111 a fourth collecting channel 114 projects into the first space. In this case the fourth collecting channel 114 also has a contour which is at first horizontal and is then angled or curved upward.

In this embodiment the fifth bearing 111 is a ball bearing, whereas the first bearing 104, the second bearing 105, the third bearing 109 and the fourth bearing 110 are all conical roller bearings.

The lubricant entrained by the first rotating component 100 and later thrown off of it is caught by the collecting channel 113 and the fourth collecting channel 114. On the side of the fifth bearing 111 facing toward the first rotating component 100, the contour of the fourth collecting channel 114 forms a lubricant reservoir by virtue of which, during driving operation, lubricant is supplied to the fifth bearing 111 to cool it and reduce wear. Analogously, lubricant is caught by the contour of the collecting channel 113 and supplied to the third bearing 109. The lubricant is dispersed in the third bearing 109 and then passes through the third bearing 109 from the first space into the second space, where it flows downward along the partition wall 112. Since the third bearing 109 is arranged with its smaller diameter on the side facing toward the collecting channel 113 and its larger diameter on the side facing toward the fourth rotating component 107, the lubricant flow just described is favored or assisted by the conveying action of the third bearing 109.

The lubricant collects in the lower part of the second space with the result that the third rotating component 106 is at least partially immersed in the lubricant, carries some of it up analogously to the first rotating component 100, and disperses it in the second space. The lubricant not carried up by the third rotating component 106 supplies lubricant to the point of engagement between the third rotating component 106 and the fourth rotating component 107, whereby at least a small part of the lubricant in contact with the fourth rotating component 107 is also thrown off and dispersed in the second space.

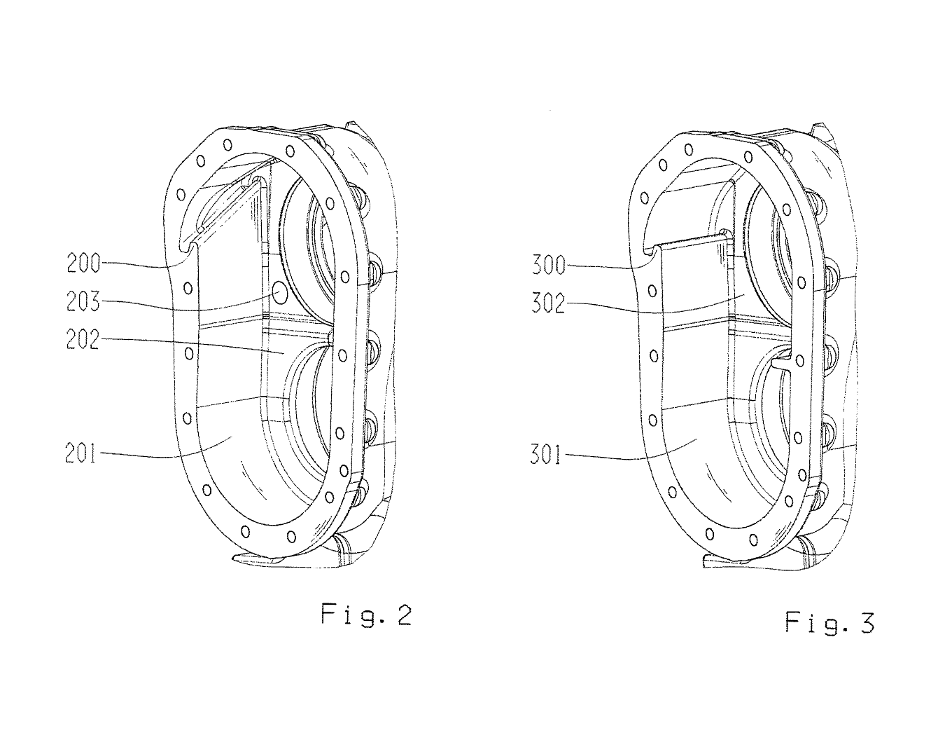

The lubricant dispersed by the third rotating component 106 and the fourth rotating component 107 is caught by a second collecting channel 200 shown in FIG. 2, and passed by way of a channel to behind the fourth bearing 110. Assisted among other things by the conveying action of the fourth bearing 110, the lubricant flows through it and returns again to the lower part of the second space. The first bearing 104 is supplied with lubricant, on the one hand, by the lubricant thrown up by the first rotating component 100 in the first space and, on the other hand, by the lubricant thrown up by the third rotating component 106 in the second space. Moreover, the conveying action of the first bearing 104 has the result that part of the lubricant collected in the second space is transferred back through the first bearing 104 from the second space into the first space. The second bearing 105 is supplied by lubricant, on the one hand, by the lubricant thrown up by the third rotating component 106, while in addition the conveying action of the second bearing 105 ensures that lubricant present in the second space is passed into the second bearing 105.

FIG. 2 shows a perspective representation of a possible design form of a second collecting channel 200. In this example the second collecting channel 200 has an inclination and extends along a wall of the housing 201, from its upper end on the partition wall 202, across the wall of the housing 201 as far as another channel (not shown here).

In addition a bore 203 is shown in the partition wall 202. This bore 203 opens, on the side of the partition wall 202 facing away from the second collecting channel 200, into the first space described in FIG. 1. The bore 203 is positioned so that lubricant present in the collecting channel 113 described in FIG. 1 can additionally pass through the bore 203 from the collecting channel 113 into the second space. This improves the inflow of lubricant into the second space.

FIG. 3 shows, again in a perspective view, another embodiment of the collecting channel 200 described in FIG. 2, in this case indexed 300. Analogously, the housing 301 and the partition wall 302 are also shown.

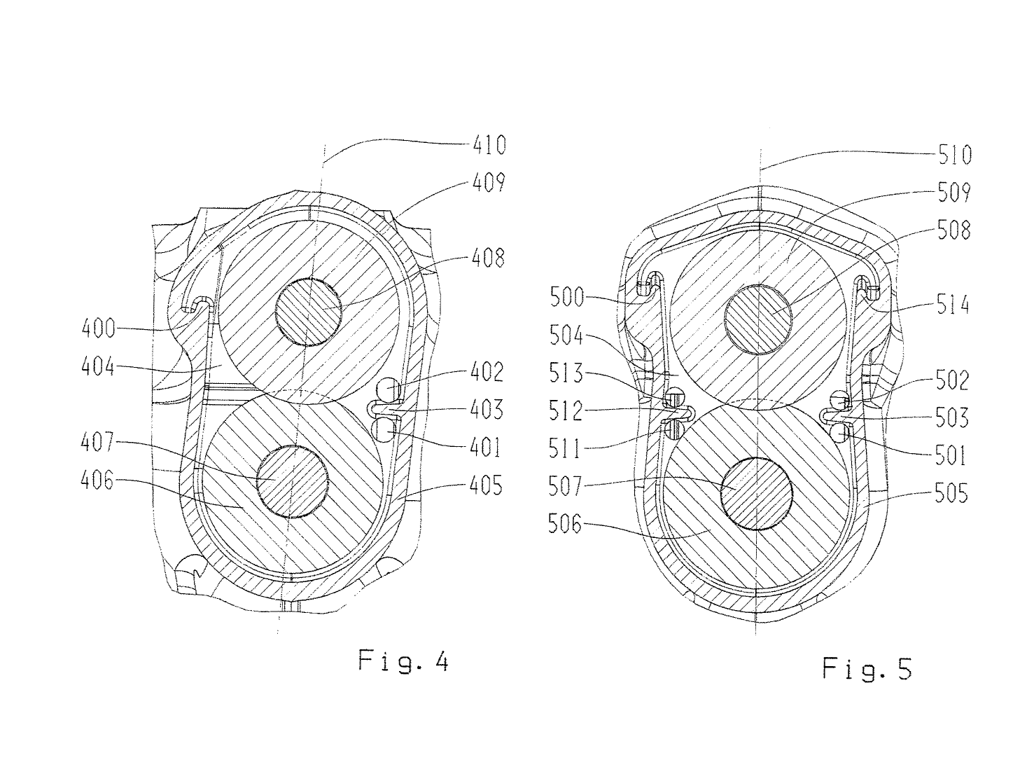

FIG. 4 is a sectional drawing of a possible design form of the second collecting channel 400, an opening 401 and a second opening 402 separated from the opening 401 by a collecting rib 403. The lubricant in the lower part of the second space delimited by the partition wall 404 and the housing 405 is partially carried up by the third rotating component 406 as described in FIG. 1, and later thrown off again, and is thus dispersed in the second space.

In addition the first shaft 407 and the second shaft 408 as well as the fourth rotating component 409 are also shown. Some of the lubricant thrown off by the third rotating component 406 splashes against the collecting rib 403 and is thus caught and passed into the opening 401.

Another part of the lubricant thrown up is caught by the second collecting channel 400 and passed behind the fourth bearing 110 described in FIG. 1. A further part of the lubricant that has not been caught by the second collecting channel 400 flows down over the side of the housing 405 opposite the second collecting channel 400 and either passes directly into the second opening 402, or is caught by the collecting rib 403 and led into the second opening 402. Furthermore, FIG. 4 shows a line of symmetry 410 that passes through the respective mid-points of the first shaft 407 and second shaft 408.

FIG. 5 shows among other things the third rotating component 506, which is connected in a rotationally fixed manner to the first shaft 507, and the fourth rotating component 509, which is connected in a rotationally fixed manner to the second shaft 508. The housing 505 surrounds the third rotating component 506 and the fourth rotating component 509. The second space, in which the third rotating component 506 and the fourth rotating component 509 are located, is delimited by the housing 505 and the partition wall 504. The third rotating component 506 is at least partially immersed in the lubricant collected in the lower part of the second space, and carries some of that lubricant up with it.

At the level of the engagement point between the third rotating component 506 and the fourth rotating component 509 there projects on one side as an extension of the housing 505 a collecting rib 503, in this case approximately horizontally, into the second space along the partition wall 504. Under the collecting rib 503, the partition wall 504 has an opening 501. Above and adjacent to the collecting rib 503 is the second opening 502. Mirror-symmetrically relative to the line of symmetry 510 that passes through the respective mid-points of the second shaft 508 and the first shaft 507, a second collecting rib 512 is positioned on the side opposite the collecting rib 503.

In addition, a third opening 511 is arranged mirror-symmetrically relative to the opening 501 and a fourth opening 513 is arranged mirror-symmetrically relative to the second opening 502. Some of the lubricant thrown up by the third rotating component 506 is caught by the collecting rib 503 or by the collecting rib 512 and passed, respectively, into the opening 501 or the third opening 511.

The lubricant not caught by the collecting rib 503 or the second collecting rib 512 is either thrown off by centrifugal force from the third rotating component 506 and again dispersed in the second space, or it lubricates the engagement point between the third rotating component 506 and the fourth rotating component 509. The lubricant transferred to the fourth rotating component 509 in this way is also partially thrown off from the fourth rotating component 509 by the rotational movement, and thus dispersed in the second space.

The lubricant splashes against the housing 505 and flows down under the force of gravity. The second collecting channel 500 fixed in the housing 505 or the third collecting channel 514 opposite thereto, catch the lubricant and pass it behind the fourth bearing 110 described in FIG. 1. In the present example the second collecting channel 500 and the third collecting channel 514 are arranged opposite one another mirror-symmetrically relative to the line of symmetry 510.

Lubricant that could not be caught by the second collecting channel 500 or the third collecting channel 514 flows downward along the housing 505 under the force of gravity. Some of this lubricant is caught by the collecting rib 503 or the second collecting rib 512, and thereby prevented from flowing down any further, and passed into the second opening 502 or the fourth opening 513 in the partition wall 504. During normal driving operation, the opening 501, the second opening 502, the third opening 511 and the fourth opening 513 are positioned higher than the lubricant surface in the second space. This arrangement further ensures that complete displacement of the lubricant out of the first space into the second space is prevented. In this case the arrangement of the opening 501 and the third opening 511 has the result that even without rotational movement, the lubricant passes from the second space back into the first space.

The present arrangement, being symmetrically structured relative to the line of symmetry 510, has the advantage that the change of rotational direction, for example of the third rotating component 506, caused by driving forward or in reverse, has no influence on the circulation of the lubricant in the second space.

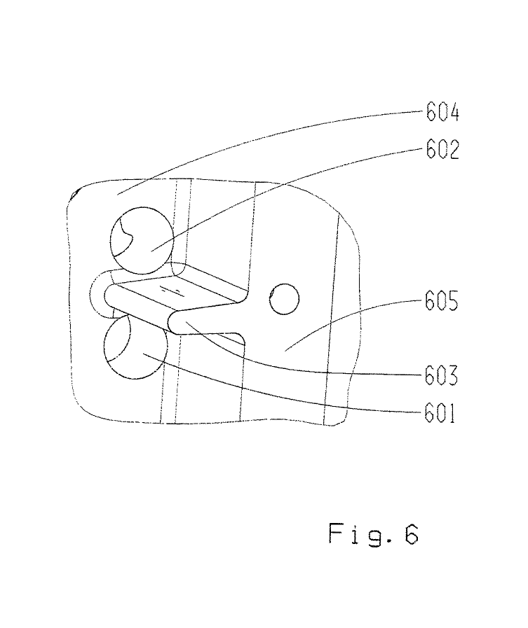

FIG. 6 shows a perspective section of the housing 605 and the partition wall 604. From the housing 605 the collecting rib 603 projects along the partition wall 604 into the second space delimited by the housing 605 and the partition wall 604. The opening 601 is positioned close to the wall of the housing 605 under the collecting rib 603. The second opening 602 is positioned close to the housing wall 605, above the collecting rib 603.

### INDEXES

100 First rotating component
101 Housing
102 Second rotating component
103 First shaft
104 First bearing
105 Second bearing
106 Third rotating component
107 Fourth rotating component
108 Second shaft
109 Third bearing
110 Fourth bearing
111 Fifth bearing
112 Partition wall
113 Collecting channel
114 Fourth collecting channel
200 Second collecting channel
201 Housing
202 Partition wall
203 Bore
300 Second collecting channel
301 Housing
302 Partition wall
400 Second collecting channel
401 Opening
402 Second opening
403 Collecting rib
404 Partition wall
405 Housing
406 Third rotating component
407 First shaft
408 Second shaft
409 Fourth rotating component
410 Line of symmetry
500 Second collecting channel
501 Opening
503 Collecting rib
504 Partition wall
505 Housing
506 Third rotating component
507 First shaft
508 Second shaft
509 Fourth rotating component
510 Line of symmetry
511 Third opening
512 Second collecting rib
513 Fourth opening
514 Third collecting channel
601 Opening
602 Second opening
603 Collecting rib
604 Partition wall
605 Housing

1-11. (canceled)

12. An oiling device for an axle with spur gearing, the oiling device comprising:
a first rotating component (100) being surrounded by a housing (101, 201, 301, 405, 505, 605) and immersible in a lubricant,
a first shaft (103, 407, 507) being rotatably mounted by a first bearing (104) and a second bearing (105),
the first shaft being connected, in a rotationally fixed manner, to a second rotating component (102) and to a third rotating component (106, 406, 506), and the second rotating component (102) being arranged above a surface of the lubricant and engaging with the first rotating component (100),
a fourth rotating component (107, 409, 509) being connected, in a rotationally fixed manner, to a second shaft (108, 408, 508) that is arranged in a spaced relationship from the first shaft (103, 407, 507),
the lubricant being at least partially carried up by the first rotating component (100), and then thrown off by rotational movement of the first rotating component (100) and thereby dispersed within the housing (101, 201, 301, 405, 505, 605),
the second shaft (108, 408, 508) and the first rotating component (100) being arranged in the housing (101, 201, 301, 405, 505, 605), and
the lubricant, thrown off by the rotational movement of the first rotating component (100), being catchable by at least one collecting channel (113) and selectively dispersed.

13. The oiling device for an axle with spur gearing according to claim 12, wherein a partition wall (112, 202, 302, 404, 504, 604) divides the housing (101, 201, 301, 405, 505, 605) between the second rotating component (102) and the third rotating component (106, 406, 506) and the fourth rotating component (107, 409, 509), into a first space and a second space such that at least the first rotating component (100) is in the first space and at least the third rotating component (106, 406, 506) and the fourth rotating component (107, 409, 509) are in the second space.

14. The oiling device for an axle with spur gearing according to claim 13, wherein the lubricant that is thrown up by the first rotating component (100) passes, by way of the collecting channel (113) in the first space, to a third bearing (109) by way of which the second shaft (108, 408, 508) is rotatably mounted, on a side of the fourth rotating component (107, 409, 509) facing toward the first rotating component (100), and the lubricant passes through the third bearing (109) from the first space into the second space.

15. The oiling device for an axle with spur gearing according to claim 14, wherein the third rotating component (106, 406, 506), present in the second space, is immersible in the lubricant contained therein, and a second collecting channel (200, 300, 400, 500) is arranged in the second space, inside the housing (101, 201, 301, 405, 505, 605), such that the lubricant that is thrown up by the third rotating component (106, 406, 506) is catchable and passes, by way of another channel, to a fourth bearing (110), by way of which the second shaft (108, 408, 508) is rotatably mounted on a side of the fourth rotating component (107, 409, 509) facing away from the first rotating component (100).

16. The oiling device for an axle with spur gearing according to claim 15, wherein the second collecting channel (200, 300, 400, 500) is arranged either horizontally or inclined.

17. The oiling device for an axle with spur gearing according to claim 16, wherein a third collecting channel (514) is arranged in the housing (101, 201, 301, 405, 505, 605) on an opposite side relative to the second collecting channel (200, 300, 400, 500).

18. The oiling device for an axle with spur gearing according to claim 14, wherein the partition wall (112, 202, 302, 404, 504, 604) has at least a first opening (401, 501, 601) therein.

19. The oiling device for an axle with spur gearing according to claim 18, wherein the first opening (401, 501, 601) and a second opening (402, 502, 602), arranged above the first opening (401, 501, 601), are positioned directly adjacent to a collecting rib (403, 503, 603) that is arranged between the first opening (401, 501, 601) and the second opening (402, 502, 602), and the collecting rib (403, 503, 603) projects into the second space in a form of a raised ridge along the partition wall (112, 202, 302, 404, 504, 604).

20. The oiling device for an axle with spur gearing according to claim 19, wherein a third opening (511) and a fourth opening (513), above the third opening (511), are arranged directly adjacent to a second collecting rib (512) positioned between the third opening (511) and the fourth opening (513), and the second collecting rib (512) projects into the second space in a form of a raised ridge along the partition wall (112, 202, 302, 404, 504, 604) such that the third opening (511), the fourth opening (513) and the second collecting rib (512) are arranged on the opposite side of the housing (101, 201, 301, 405, 505, 605) relative to the first opening (401, 501, 601), the second opening (402, 502, 602) and the collecting rib (403, 503, 603).

21. The oiling device for an axle with spur gearing according to claim 12, wherein the lubricant thrown up by the rotational movement of the first rotating component (100) is catchable by a fourth collecting channel (114) which is arranged on the side of the housing (101, 201, 301, 405, 505, 605) opposite the fourth rotating component (107, 409, 509), the lubricant is supplied to a fifth bearing (111), and the second shaft (108, 408, 508) is rotatably mounted by the fifth bearing (111) on the opposite side of the fourth rotating component (107, 409, 509).

22. An oiling device in conjunction with an axle having spur gearing, the oiling device comprising:
a first rotating component (100) being surrounded by a housing (101, 201, 301, 405, 505, 605) and immersible in a lubricant,
a first shaft (103, 407, 507) being rotatably mounted by a first bearing (104) and a second bearing (105),
the first shaft being connected, in a rotationally fixed manner, to a third rotating component (106, 406, 506) and to a second rotating component (102), the second rotating component (102) being arranged above a surface of the lubricant and engaging with the first rotating component (100),
a fourth rotating component (107, 409, 509) being connected, in a rotationally fixed manner, to a second shaft (108, 408, 508) spaced from the first shaft (103, 407, 507),
the lubricant is at least partially carried up by the first rotating component (100) and thrown off, by rotational movement of the first rotating component (100), and dispersed within the housing (101, 201, 301, 405, 505, 605),
the second shaft (108, 408, 508) and the first rotating component (100) being arranged within the housing (101, 201, 301, 405, 505, 605), and
the lubricant thrown off by the rotational movement of the first rotating component (100) being catchable by at least one collecting channel (113) and selectively dispersed within the housing (101, 201, 301, 405, 505, 605).

23. An oiling device for an axle with spur gearing, the oiling device comprising:
a first rotating component being housed within a housing, the housing containing a lubricant which fills an interior of the housing up to a lubricant level, and the first rotating component being immersed in a lubricant;
a first shaft being rotationally supported by first and second bearings, the first shaft being continuously connected to second and third rotating components;
the second rotating component engaging with the first rotating component and the first shaft being supported such that the second rotating component being positioned above the lubricant level;
a second shaft being rotationally supported, via third and fourth bearings, within the housing, and a fourth rotating component being continuously connected to the second shaft spaced away from the first shaft;
a partition wall dividing an interior of the housing into first and second spaces such that the first and the second rotating components are located in the first space and the third and the fourth rotating components are located in the second space, the partition wall supporting the third bearing which rotationally supports the second shaft arranged in the first space, and the partition wall comprises a collecting channel which extends into the first space; and
the first rotating component being located in the first space such that rotation of the first rotating component displaces lubricant within the first space, and the collecting channel being arranged such that displaced lubricant is collected via the collecting channel and flows toward the third bearing and through the third bearing from the first space into the second space.
